(19) United States
(12) Patent Application Publication
(10) Pub. No.: US 2019/0124862 A1
(43) Pub. Date: May 2, 2019

(54) Accelerated Plant-Growing System

(71) Applicant: Raymond E. Mays, Glassport, PA (US)

(72) Inventor: Raymond E. Mays, Glassport, PA (US)

(21) Appl. No.: 16/177,397

(22) Filed: Oct. 31, 2018

Related U.S. Application Data
(60) Provisional application No. 62/579,338, filed on Oct. 31, 2017.

(51) Int. Cl. A01G 31/00; A01G 7/04; A01G 7/02

(52) U.S. Cl. CPC A01G 31/00; A01G 2031/006; A01G 7/02; A01G 7/045

(57) ABSTRACT

An accelerated plant-growing system is an apparatus that facilitates plant growth with the application of hydroponics and aeroponics. The apparatus includes a water-leveling distribution assembly, a plurality of planter assemblies, at least one spraying system, a manifold system, and a water supplying system. The water-leveling distribution assembly is the hydroponics application of the apparatus. The at least one spraying system is the aeroponics application of the apparatus. The water-leveling system submerges the roots housed by the plurality of planter assemblies in nutrient-rich water and upholds the plurality of planter assemblies. The at least one spraying system emits nutrient-rich water to the soil. The manifold system delivers nutrient-rich water to the at least one spraying system from the water supplying system. The apparatus further includes a cooler, a light source and a carbon dioxide supply in order to further facilitate plant growth.

The current application claims a priority to the U.S. Provisional Patent application Ser. No. 62/579,338 filed on Oct. 31, 2017.

### FIELD OF THE INVENTION

The present invention relates generally to hydroponics and aeroponics. More specifically, the present invention is an accelerated plant-growing system that continuously supplies nutrient-rich water to plants with the application of both hydroponics and aeroponics.

### BACKGROUND OF THE INVENTION

Indoor plants have become increasingly popular as indoor plants are more easily accessible and therefore have higher chances of being better maintained. Growing plants indoors also allows plants to be grown year-round and within a controlled environment. Controlled environments yield better quality of plants, bigger and plants. Moreover, the growth rate of plants can also be controlled and accelerated.

Two common indoor methods of growing indoor plants include aeroponics and hydroponics. Aeroponics systems, however, work best with only herbs or very small plants due to the plant sites of the system being so close to one another. Larger plants such as marijuana, tomatoes, and green peppers easily die or have terrible yields because the roots grow together and create blockage of nutrient flow. The root growth within a limited space creates root rot and the actual plants starve each other for light. Hydroponic systems yield more consistent results, but a limited amount of plants. For both aeroponic systems and hydroponic systems, maintenance is tedious and repetitive in order to keep the system free of bacteria and any nutrient build up.

It is therefore an objective of the present invention to enhance current systems and facilitate plant growth without compromising quality. The present invention accelerates plant growth, preferably for indoor plants. The present invention combines both hydroponics and aeroponics. The present invention separates the environment for the soil and the roots from the environment for plant.

### BRIEF DESCRIPTION OF THE DRAWINGS

FIG. 1 is a top perspective view of the present invention.

FIG. 2 is a top side view of the present invention.

FIG. 3 is a cross-section view of FIG. 2 along line 3-3 of the present invention.

FIG. 4 is an exploded view a planter assembly of a plurality of planter assemblies of the present invention.

FIG. 5 is a schematic view of electronic components, a cooler, and a light source of the present invention.

FIG. 6 is a schematic view of a manifold system, a feed spike, and a feed spike coupler of the present invention.

### DETAILED DESCRIPTION OF THE INVENTION

All illustrations of the drawings are for the purpose of describing selected versions of the present invention and are not intended to limit the scope of the present invention.

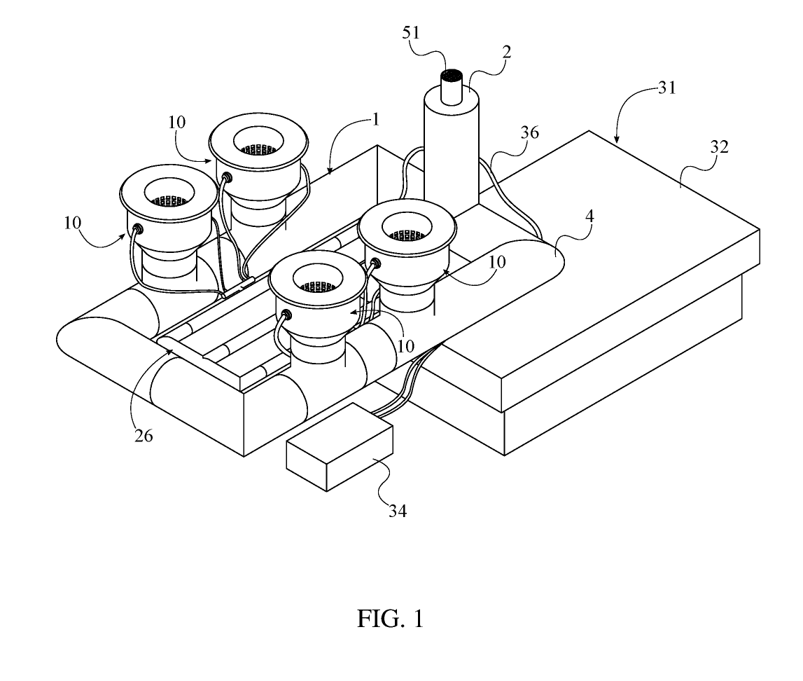

The present invention is an accelerated plant-growing system that utilizes both hydroponics and aeroponics. The present invention provides continuous nutrient-rich water to plants with a self-regulating reservoir 32. In order for the present invention to produce the precise conditions which facilitate plant growth, the present invention comprises a water-leveling distribution assembly 1, a plurality of planter assemblies 10, at least one spraying mechanism, a manifold system 26, and a water supplying system 31. the water-leveling distribution assembly 1, as seen in FIG. 1, The present invention utilizes hydroponics in order to provides consistent exposure of nutrient-rich water to plants. The water-leveling distribution assembly 1 houses nutrient-rich water within the nutrient-rich water. More specifically, the roots are directly submerged in the nutrient-rich water. A specific portion of the roots are submerged in the nutrient-rich water as water-leveling distribution assembly 1 comprises a vertical leveling tube 2 and at least one horizontal distribution tube 4. The vertical leveling tube 2 and the at least one horizontal distribution tube 4, together, regulate the water level within the plurality of planter assemblies 10. The plurality of planter assemblies 10 house the plants, soil, and grow stones. Moreover, the plurality of planter assemblies 10 suspends plants within the water-leveling distribution assembly 1, thereby exposing the roots directly to the nutrient-rich water. The at least one spraying system utilizes aeroponics by directly spraying the soil within the plurality of planter assemblies 10 with nutrient-rich water. The manifold system 26 distributes the nutrient-rich water to the at least one spraying system with the water supplying system 31. The water supplying system 31 comprises a reservoir 32. The reservoir 32 houses the nutrient-rich water. In the preferred embodiment of the present invention, the reservoir 32 is a 40-gallon reservoir 32.

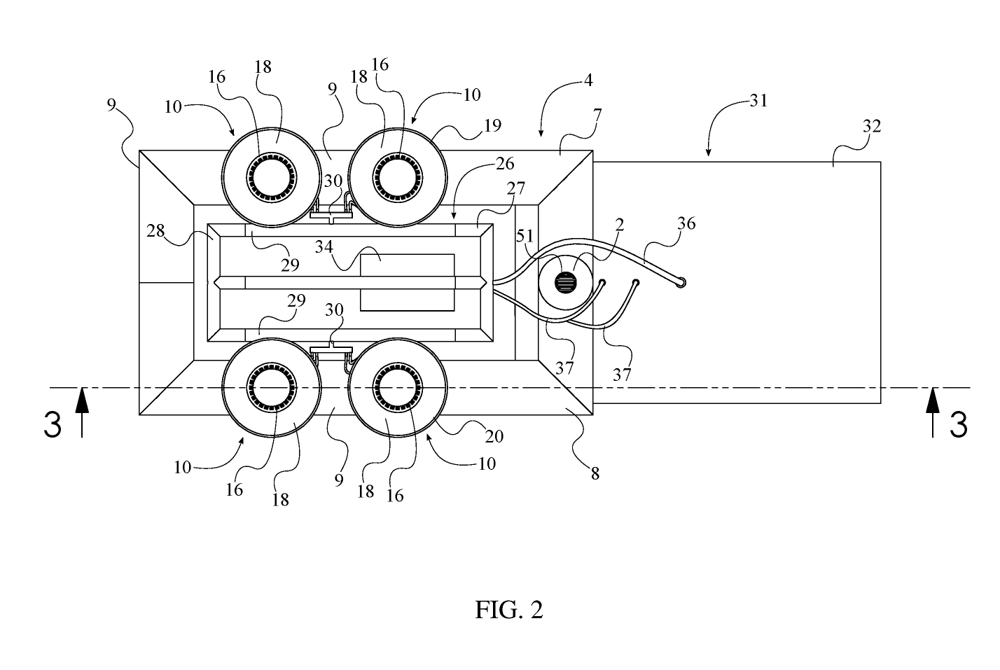

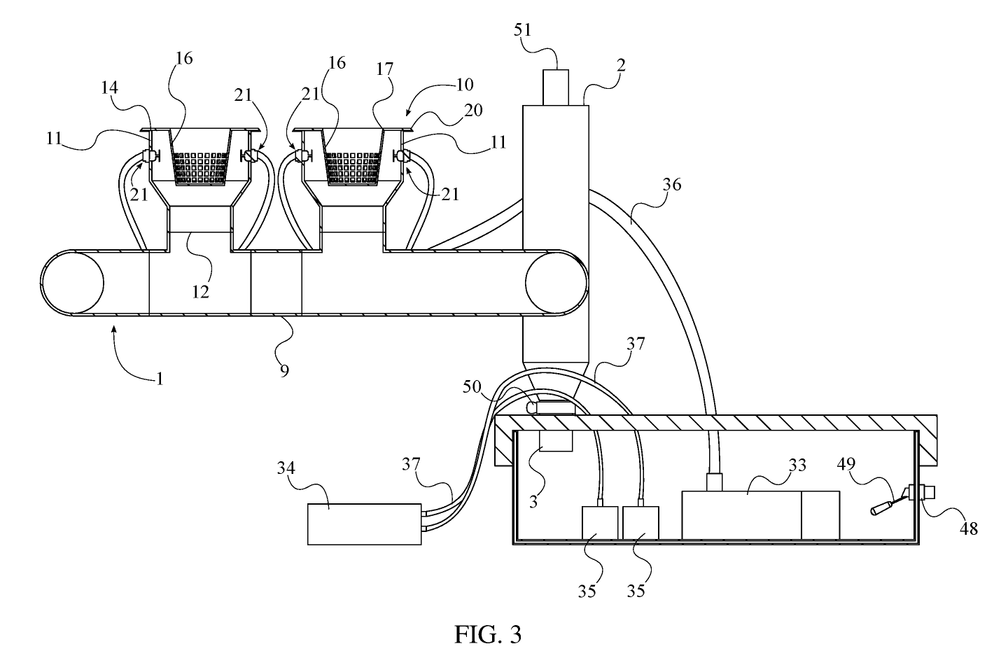

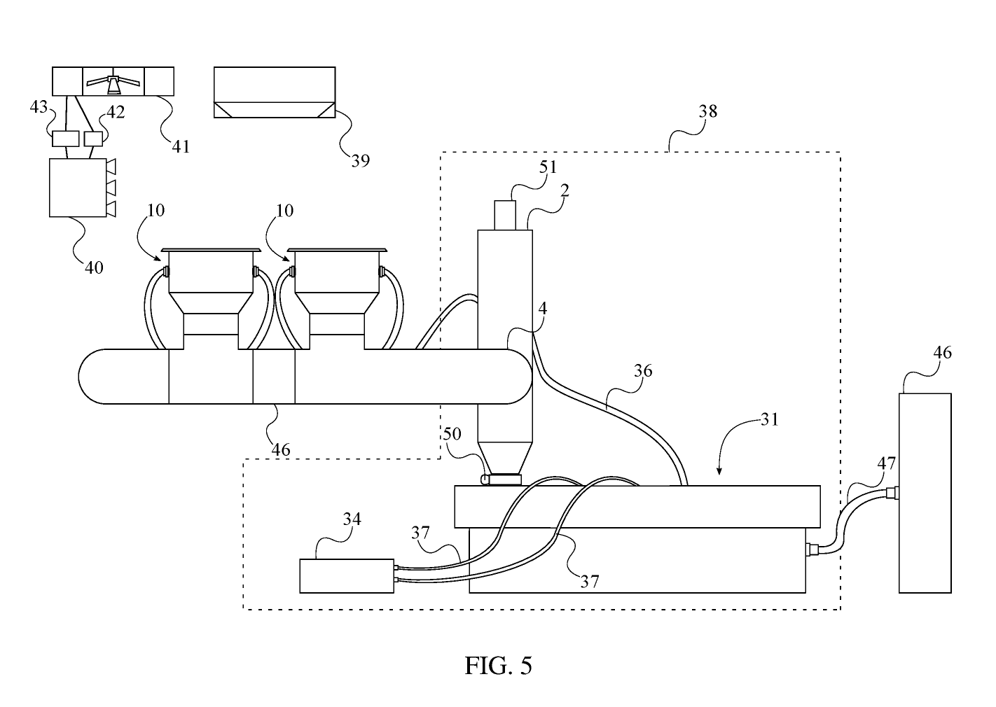

The overall configuration of the aforementioned components delivers nutrient-rich water to the soil the plants are growing within and suspends the roots within nutrient-rich water. As seen in FIG. 1, FIG. 2, FIG. 3, and FIG. 5, each planter assembly of the plurality of planter assemblies 10 is terminally mounted onto the at least one horizontal distribution tube 4, allowing the nutrient-rich water within the at least one horizontal distribution tube 4 to traverse into each planter assembly of the plurality of planter assemblies 10. The water level within each planter assembly of the plurality of planter assemblies 10 is regulated as the at least one horizontal distribution tube 4 is connected in between each planter assembly of the plurality of planter assemblies 10 and the vertical leveling tube 2. In order to spray nutrient-rich water directly onto the soil the plants are growing within, the at least one spraying system is mounted into each planter assembly of the plurality of planter assemblies 10. The nutrient-rich water is delivered from the reservoir 32 to the at least one spraying system as the at least one spraying system is in fluid communication with the water supplying system 31 through the manifold system 26. The excess nutrient-rich water from the at least one spraying system is housed within the at least one horizontal distribution tube 4 as each planter assembly of the plurality of planter assemblies 10 is in fluid communication with the at least one horizontal distribution tube 4. This arrangement submerges the roots within nutrient-rich water. The water level within each planter assembly of the plurality of planter assemblies 10 and the at least one horizontal distribution tube 4 is regulated as the at least one distribution tube 4 is in fluid communication with the vertical leveling tube 2. If the water level exceeds the desired height within each planter assembly of the plurality of planter assemblies 10, the nutrient-rich water contained within the water-leveling distribution assembly 1 is released back into the reservoir 32. In order to release the nutrient-rich water into the reservoir 32, the vertical leveling tube 2 is in fluid communication with the reservoir 32.

The present invention further provides an ideal environment for accelerated plant growth as the present invention further comprises a cooler 38 and a light source 39, seen in FIG. 5. The cooler 38 and the light source 39 defines separate environments for the plant and the soil. More specifically, the cooler 38 achieves a water-baseline temperature of approximately 65 degrees to 70 degrees while the light source 39 provides the desired warmth to the plant, providing the ideal environments for both the soil and the plant. In the preferred embodiment of the present invention, the light source 39 is an artificial source that provides heat. Moreover, the light source 39 is preferably a light emitting diode (LED) light source 39. In order to effectively cool the nutrient-rich water before it reaches the soil, the water supplying system 31 is positioned within the cooler 38. In alternate embodiments of the present invention, the temperature of specifically the reservoir 32 may be cooled and maintained. In order to achieve the desired temperature of the nutrient-rich water before it reaches the soil and the desired temperature for the plant, the plurality of planter assemblies 10 and the manifold system 26 is positioned external to the cooler 38. Furthermore, the temperature of the environment for the plant is heated as the light source 39 is positioned external and adjacent to the plurality of planter assemblies 10. This arrangement effectively provides a cool environment for soil and roots while providing a warm environment for the plant.

The growth of the plant is further facilitated as an alternate embodiment of the present invention comprises a carbon dioxide supply 40, an exhaust fan 41, a microcontroller 42, and a power source 43, seen in FIG. 5. The carbon dioxide supply 40 provides increased amounts of carbon dioxide for the plant, and the exhaust fan 41 removes the carbon dioxide within the surrounding environment of the present invention. The exhaust fan 41 provides a safe environment for users to access the present invention as the carbon dioxide supply 40 increases the carbon dioxide within a designate space or room which houses the present invention. The microcontroller 42 automatically controls the exhaust fan 41 such that the flow of carbon dioxide is intermittent as constant exposure to carbon dioxide is harmful to the plant. The power supply delivers the necessary power to the exhaust fan 41 and the microcontroller 42. The carbon dioxide supply 40, the exhaust fan 41, the microcontroller 42, and the power source 43 are positioned external to the plurality of planter assemblies 10 such that only the plant is exposed to the carbon dioxide, and not the soil nor the root. the exhaust fan 41 is positioned adjacent to and oriented towards the plurality of planter assemblies 10 to maximize the intake of carbon dioxide by the plant. The emission of carbon dioxide is automatic as the microcontroller 42 is electronically connected to the external carbon dioxide supply 40 and the exhaust fan 41, and the power source 43 is electrically connected to the microcontroller 42, the external carbon dioxide supply 40, and the exhaust fan 41.

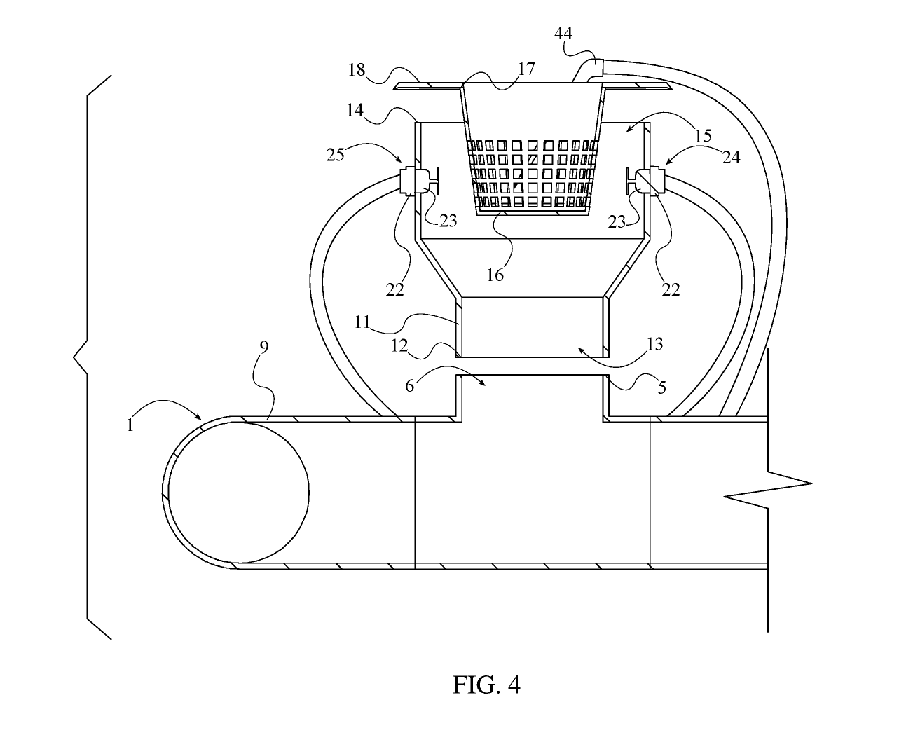

The environment for the plant is separated from the environment of the soil and roots as each planter assembly of the plurality of planter assemblies 10 comprises a frame 11, a net pot basket 16, and a basket lid 18, seen in FIG. 4. The frame 11 suspends the net pot basket 16 with the basket lid 18 and encloses nutrient-rich water with a corresponding horizontal distribution tube 4 of the at least one horizontal distribution tube 4. The net pot basket 16 houses the soil and the roots and upholds the plant. The basket lid 18 also encloses the frame 11 such that the soil and roots within the frame 11 is exposed only to the nutrient-rich water from the at least one spraying system. Moreover, only the plant is exposed to the heat from the light source 39 is as the basket lid 18 seals the frame 11. In order to submerge the roots within a collection of excess nutrient-rich water while maintaining a desired water level, the at least one horizontal distribution tube 4 is laterally connected to the vertical leveling tube 2. More specifically, a first rim 12 of the frame 11 is positioned adjacent to a first rim 5 of the at least one horizontal distribution tube 4. A first opening 13 of the frame 11 is defined by the first rim 12 of the frame 11. Similarly, a first opening 6 of the at least one horizontal distribution tube 4 is defined by the first rim 5 of the at least one horizontal distribution tube 4. The water level within the frame 11 is maintained as the frame 11 is oriented parallel with the vertical leveling tube 2. Each planter assembly of the plurality of planter assemblies 10 is in fluid communication with the at least one horizontal distribution tube 4 through the first opening 13 of the frame 11 and the first opening 6 of the at least one horizontal distribution tube 4. The at least one spraying system is laterally mounted into the frame 11, positioned adjacent the second opening 15. This arrangement directs the nutrient-rich water to the soil while allowing a portion of the roots to be positioned above the water level within the frame 11. The water level is further maintained, and the growth of the roots is controlled as the frame 11 tapers from the second opening 15 to the first opening 13.

The environment within frame 11 is separated from the environment of the plant as the basket lid 18 is perimetrically fixed across the first rim 17 of the net pot basket 16, as seen in FIG. 4. The plant grows from the soil within the frame 11 and through the first rim 17 of the net pot basket 16, opposite the frame 11. Moreover, the net pot basket 16 is suspended from a second rim 14 of the frame 11 with the basket lid 18. A second opening 15 of the frame 11 is defined by the second rim 14, and the second rim 14 is positioned opposite the first rim 12 of the frame 11, across the frame 11.

In order for the water supplying system 31 to deliver the nutrient-rich water from within the reservoir 32 to the manifold, the water supplying system 31 further comprises a pump 33, a compressor 34, at least one air stone 35, a water delivery line 36, and at least one oxygen delivery line 37, shown in FIG. 3. The pump 33 forces the nutrient-rich water within the reservoir 32 to the manifold through the water delivery line 36. The compressor 34 delivers air into the nutrient-rich water with the at least one oxygen delivery line 37. The amount of air within the nutrient-rich water is evenly distributed within the nutrient filled water and is maximized with the at least one air stone 35. In order to evenly and thoroughly apply the nutrient-rich water to the soil, the at least one spraying system comprises an adapter 22 and a sprayer nozzle 23. The nutrient-rich water is delivered from the reservoir 32 to the sprayer nozzle 23 as the pump 33 is positioned within the reservoir 32. The at least one air stone 35 is also positioned within the reservoir 32 so that the nutrient-rich water is effectively aerated. The compressor 34 delivers oxygen to the nutrient-rich water within the reservoir 32 as the compressor 34 is positioned external to the reservoir 32 and is in fluid communication with the at least one air stone 35 through the at least one oxygen delivery line 37. The adapter 22 is laterally integrated into each planter assembly of the plurality of planter assemblies 10, and the sprayer nozzle 23 is terminally connected to the adapter 22, thereby orienting the sprayer nozzle 23 towards the soil. Moreover, the sprayer nozzle 23 is positioned within the planter assembly. The nutrient-rich water is automatically delivered to the sprayer nozzle 23 as the pump 33 is in fluid communication with the manifold system 26 through the water delivery line 36, and the manifold system 26 is in fluid communication with the sprayer nozzle 23 through the adapter 22. It is understood that the necessary tubing connects the manifold system 26 to the adapter 22.

In alternate embodiments of the present invention the reservoir 32 comprises a drainage system. In these alternate embodiments, the reservoir 32 is automatically relieved of the nutrient-rich water that has been cycled through the present invention multiple times. The drainage system comprises a release door and a drain line that directs the nutrient-rich water to a sewage tank.

In the preferred embodiment of the present invention, the at least one spraying system comprises a first sprayer 24 and second sprayer 25, seen in FIG. 4. The first sprayer 24 is positioned opposite the second sprayer 25 about each planter assembly of the plurality of planter assemblies 10. This preferred embodiment both provides the necessary flow of nutrient-rich water to the soil. In alternate embodiments of the present invention however, a plurality of sprayer may be distributed about each planter assembly of the plurality of planter assemblies 10.

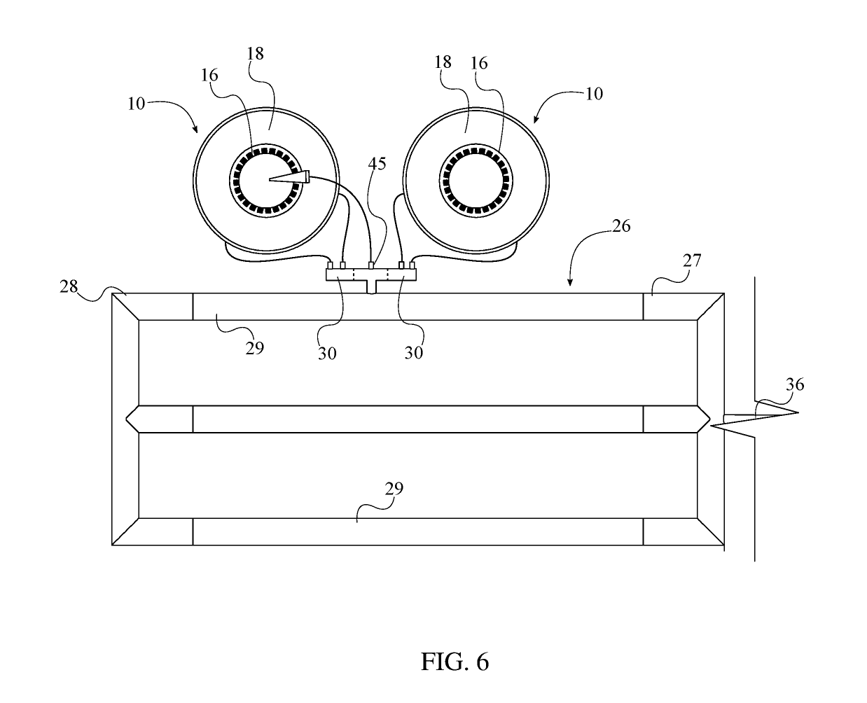

In order to provide a continuous flow of nutrient-rich water to the at least one sprayer system 21, the manifold system 26 comprises a feed manifold 27, a circulation manifold 28, at least one main line 29, and at least one sprayer coupler 30, seen in FIG. 2 and FIG. 6. The feed manifold 27 directs the nutrient-rich water from the reservoir 32 to the at least one main line 29. The circulation manifold 28 allows for a continuous flow of nutrient-rich water through the at least one main line 29. The at least one main line 29 distributes the nutrient-rich water to the at least one sprayer coupler 30. Moreover, the at least one main line 29 is connected in between the feed manifold 27 and the circulation manifold 28, and the at least one sprayer coupler 30 is laterally connected along the at least one main line 29. In order to deliver nutrient-rich water to the at least one spraying system, the water supplying system 31 is in fluid communication with the feed manifold 27. The feed manifold 27 is in fluid communication with the circulation manifold 28 through the at least one main line 29. The at least one main line 29 is in fluid communication with the at least one sprayer system 21 through the at least one sprayer coupler 30.

An alternate embodiment of the present invention further comprises a feed spike 44 and a feed spike coupler 45, seen in FIG. 4 and FIG. 6. The feed spike 44 provides nutrient-rich water directly into the soil, whereas the at least one sprayer system 21 applies nutrient-rich water externally to the soil. The feed spike coupler 45 connects the feed spike 44 to the at least one main line 29. As each planter assembly of the plurality of planter assemblies 10 comprises a frame 11 and a net pot basket 16, and the soil is contained within the net pot basket 16, the feed spike 44 is positioned within the net pot basket 16. Moreover, an outlet 3 of the feed spike 44 is positioned within the net pot basket 16. As the nutrient-filled water is externally applied to the soil with the at least one sprayer coupler 30, the feed spike 44 couple is connected in between the at least one sprayer coupler 30 and the at least one main line 29. The at least one main line 29 is in fluid communication with the feed spike 44 through the feed spike coupler 45, thereby preserving the continuous flow of nutrient-rich water.

In order for the reservoir 32 to be automatically refilled with water and the nutrient-filled water to be cycled through the present invention, the present invention further comprises an external water supply 46, a water supply line 47, a coupler 48, a shut-off valve 49, and an automatic drain 50, seen in FIG. 3 and FIG. 5. The external water supply 46 provides water for the reservoir 32 with the water supply line 47. Any desired nutrients for the plant are manually added into the reservoir 32, through a main opening of the reservoir 32 and is thoroughly mixed with the water through the force of the pump 33. The water supply line 47 is connected with the reservoir 32 with the coupler 48. The shut-off valve 49 maintains the water level within the reservoir 32. The automatic drain 50 maintains the water level within the water-leveling distribution assembly 1 and refills the reservoir 32 with the excess nutrient-filled water. In order to direct water from the external water supply 46 into the reservoir 32, the coupler 48 is integrated into in inlet of the reservoir 32, and the water supply line 47 is connected in between the external water supply 46 and the coupler 48. In order to release excess nutrient filled water from the water-leveling distribution assembly 1 back into the reservoir 32, an outlet 3 of the vertical leveling tube 2 is positioned within the housing. The automatic drain 50 is integrated within the vertical leveling tube 2, positioned adjacent the outlet 3 of the vertical leveling tube 2, thereby automatically releasing excess nutrient-rich water. Once a new supply of nutrient-rich water is required and the water level of the reservoir 32 is low, the reservoir 32 is refilled as the shut-off valve 49 is mounted within the reservoir 32, adjacent the inlet. Moreover, the external water supply 46 is in fluid communication with the water supply line 47, and the water supply line 47 is in fluid communication with the reservoir 32 through the coupler 48. In order to automatically control water flow and maintain water levels, the automatic drain 50 is operatively coupled with the vertical leveling tube 2, wherein the automatic drain 50 opens and closes the outlet 3 of the vertical leveling tube 2. Similarly, the shut-off valve 49 is operatively coupled with the external water supply 46, wherein a float ball of the shut-off valve 49 opens and closes the coupler 48 with a float arm of the shut-off valve 49.

The continuous water flow is further preserved as the preferred embodiment of the present invention comprises a vent 51, seen in FIG. 1, FIG. 3, and FIG. 5. The vent 51 eliminates a cyclone from forming within the vertical leveling tube 2. The vent 51 is integrated into the vertical leveling tube 2 and is positioned opposite the outlet 3 of the vertical leveling tube 2. The arrangement of the vent 51 with the vertical leveling tube 2 maintains the water level within the water-leveling distribution assembly 1.

In the preferred embodiment of the present invention, seen in FIG. 2, the at least one horizontal distribution tube 4 comprises a first distribution tube 7 and a second distribution tube 8, and the plurality of planter assemblies 10 comprises a first planter assembly 19 and a second planter assembly 20. The vertical leveling tube 2 is connected in between the first distribution tube 7 and the second distribution tube 8. The first planter assembly 19 is terminally mounted onto the first distribution tube 7 Similarly, the second planter assembly 20 is terminally mounted onto the second distribution tube 8. The first distribution tube 7 and the second distribution tube 8 are in fluid communication with the vertical leveling tube 2, and the vertical leveling tube 2 is in fluid communication with the water supplying system 31.

In order to arrange the plurality of planter assemblies 10 in series, the water-leveling distribution assembly 1 comprises at least one connection tube 9, seen in FIG. 2, FIG. 3, and FIG. 4. The connection tube 9 provides a continuous flow of nutrient rich water between adjacent planter assemblies 10 of the plurality of planter assemblies 10. The connection tube 9 is connected in between an arbitrary planter assembly and an adjacent planter assembly of the plurality of planter assemblies 10. Moreover, the adjacent planter assembly is in fluid communication with the at least one horizontal distribution tube 4 through the connection tube 9.

Although the invention has been explained in relation to its preferred embodiment, it is to be understood that many other possible modifications and variations can be made without departing from the spirit and scope of the invention as hereinafter claimed.

What is claimed is:

1. An accelerated plant-growing system comprises:
a water-leveling distribution assembly;
a plurality of planter assemblies;
at least one spraying system;
a manifold system;
a water supplying system;
the water-leveling distribution assembly comprises a vertical leveling tube and at least one horizontal distribution tube;
the water supplying system comprises a reservoir;
each planter assembly being terminally mounted onto the at least one horizontal distribution tube;
the at least one horizontal distribution tube being connected in between each planter assembly and the vertical leveling tube;
the at least one spraying system being mounted into each planter assembly;
the at least one spraying system being in fluid communication with the water supplying system through the manifold system;
each planter assembly being in fluid communication with the at least one horizontal distribution tube;
the at least one horizontal distribution tube being in fluid communication with the vertical leveling tube; and,
the vertical leveling tube being in fluid communication with the reservoir.

2. The accelerated plant-growing system as claimed in claim 1 comprises:
a cooler;
the water supplying system being positioned within the cooler; and,
the plurality of planter assemblies and the manifold system being positioned external to the cooler.

3. The accelerated plant-growing system as claimed in claim 1 comprises:
a light source;
the light source being positioned external to the cooler; and,
the light source being positioned external and adjacent to the plurality of planter assemblies.

4. The accelerated plant-growing system as claimed in claim 1 comprises:
a carbon dioxide supply;
an exhaust fan;
a microcontroller;
a power source;
the carbon dioxide supply, the exhaust fan, the microcontroller, and the power source being positioned external to the plurality of planter assemblies;
the exhaust fan being positioned adjacent to and oriented towards the plurality of planter assemblies;
the microcontroller being electronically connected to the external carbon dioxide supply and the exhaust fan; and,
the power source being electrically connected to the microcontroller, the external carbon dioxide supply, and the exhaust fan.

5. The accelerated plant-growing system as claimed in claim 1 comprises:
each planter assembly comprises a frame, a net pot basket, and a basket lid;
the at least one horizontal distribution tube being laterally connected to the vertical leveling tube;
a first rim of the frame being positioned adjacent to a first rim the at least one horizontal distribution tube;
a first opening of the frame being defined by the first rim of the frame;
a first rim of the at least one horizontal distribution tube being defined by the first rim of the at least one horizontal distribution tube;
the frame being oriented parallel with the vertical leveling tube;
each planter assembly being in fluid communication with the at least one horizontal distribution tube through the first opening of the frame and the first opening of the at least one distribution tube;
the basket lid being perimetrically fixed across a first rim of the net pot basket;
the net pot basket being suspended from a second rim of the frame with the basket lid;
a second opening of the frame being defined by the second rim; and,
the second rim being positioned opposite the first rim of the frame, across the frame.

6. The accelerated plant-growing system as claimed in claim 5 comprises:
the at least one spraying system being laterally mounted into the frame, positioned adjacent the second opening.

7. The accelerated plant-growing system as claimed in claim 5 comprises:
the frame tapering from the second opening to the first opening.

8. The accelerated plant-growing system as claimed in claim 1 comprises:
the water supplying system further comprises a pump, a compressor, at least one air stone, a water delivery line, and at least one oxygen delivery line;
the at least one spraying system comprises an adapter and a sprayer nozzle;
the pump and the at least one air stone being positioned within the reservoir;
the compressor being positioned external to the reservoir;
the compressor being in fluid communication with the at least one air stone through the at least one oxygen delivery line;
the adapter being laterally integrated into each planter assembly;
the sprayer nozzle being terminally connected to the adapter;
the sprayer nozzle being positioned within the planter assembly;
the pump being in fluid communication with the manifold system through the water delivery line; and,
the manifold system being in fluid communication with the sprayer nozzle through the adapter.

9. The accelerated plant-growing system as claimed in claim 8 comprises:
the at least one spraying system comprises a first sprayer and a second sprayer; and,
the first sprayer being positioned opposite the second sprayer about each planter assembly.

10. The accelerated plant-growing system as claimed in claim 1 comprises:
the manifold system comprises a feed manifold, a circulation manifold, at least one main line, and at least one sprayer coupler;
the at least one main line being connected in between the feed manifold and the circulation manifold;
the at least one sprayer coupler being laterally connected along the at least one main line;
the water supplying system being in fluid communication with the feed manifold;
the feed manifold being in fluid communication with the circulation manifold through the at least one main line; and,
the at least one main line being in fluid communication with the at least one sprayer system through the at least one sprayer coupler.

11. The accelerated plant-growing system as claimed in claim 10 comprises:
a feed spike;
a feed spike coupler;
each planter assembly comprises a frame and a net pot basket;
the frame being connected to the at least one horizontal distribution tube;
the frame being in fluid communication with the at least one horizontal tube;
the net pot basket being suspended within the frame;
the feed spike being positioned within the net pot basket;
the feed spike coupler being connected in between the at least one sprayer coupler and the at least one main line; and,
the at least one main line being in fluid communication with the feed spike through the feed spike coupler.

12. The accelerated plant-growing system as claimed in claim 1 comprises:
an external water supply;
a water supply line;
a coupler;
a shut-off valve;
an automatic drain;
the coupler being integrated into an inlet of the reservoir;
the water supply line being connected between the external water supply and the coupler;
an outlet of the vertical leveling tube being positioned within the housing;
the shut-off valve being mounted within the reservoir, adjacent the inlet;
the external water supply being in fluid communication with the water supply line;
the water supply line being in fluid communication with the reservoir through the coupler;
the automatic drain being integrated within the vertical leveling tube, positioned adjacent the outlet of the vertical leveling tube;
the automatic drain being operatively coupled with the vertical leveling tube, wherein the automatic drain opens and closes the outlet of the vertical leveling tube; and,
the shut-off valve being operatively coupled with the external water supply, wherein a float ball of the shut-off valve opens and closes the coupler with a float arm of the shut-off valve.

13. The accelerated plant-growing system as claimed in claim 12 comprises:
a vent;
the vent being integrated into the vertical leveling tube; and,
the vent being positioned opposite the outlet of the vertical leveling tube.

14. The accelerated plant-growing system as claimed in claim 1 comprises:
the at least one horizontal distribution tube comprises a first distribution tube and a second distribution tube;
the plurality of planter assemblies comprises a first planter assembly and a second planter assembly;
the vertical leveling tube being connected in between the first distribution tube and the second distribution tube;
the first planter assembly being terminally mounted onto the first distribution tube;
the second planter assembly being terminally mounted onto the second distribution tube;
the first distribution tube and the second distribution tube being in fluid communication with the vertical leveling tube; and,
the vertical leveling tube being in fluid communication with the water supplying system.

15. The accelerated plant-growing system as claimed in claim 1 comprises:
the water-leveling distribution assembly comprises at least one connection tube;
the connection tube being connected between an arbitrary planter assembly and an adjacent planter assembly; and,
the adjacent planter assembly being in fluid communication with the at least one horizontal distribution tube through the connection tube.
